(19) United States
(12) Patent Application Publication
(10) Pub. No.: US 2026/0311725 A1
(43) Pub. Date: Oct. 8, 2026

(54) DATA STORAGE DEVICE WITH DEFERRED DECODING OF ANALOG READ SIGNALS

(71) Applicant: WESTERN DIGITAL TECHNOLOGIES, INC., San Jose, CA (US)

(72) Inventors: David R. Hall, Rochester, MN (US); Shad H. Thorstenson, Rochester, MN (US); Andrew Larson, Rochester, MN (US); Ali Khalili, Minneapolis, MN (US)

(21) Appl. No.: 19/169,237

(22) Filed: Apr. 3, 2025

(51) Int. Cl. G06F 3/06

(52) U.S. Cl. CPC G11B 20/10037; G06F 3/0601; G06F 3/0655; G06F 3/0676; G11B 20/10527

(57) ABSTRACT

Various illustrative aspects are directed to a data storage device, method, and one or more processing devices that are configured to: perform a read operation comprising reading data from one or more tracks on the one or more corresponding disk surfaces; store digitized analog read signals associated with the read operation in one or more buffers; and decode the digitized analog read signals following the storing the digitized analog read signals.

### BACKGROUND

Data storage devices such as disk drives comprise a disk and a head connected to a distal end of an actuator arm which is rotated about a pivot by a voice coil motor (VCM) to position the head radially over the disk. The disk comprises a plurality of radially spaced, concentric tracks for recording user data sectors and servo wedges or servo sectors. The servo sectors comprise head positioning information (e.g., a track address) which is read by the head and processed by a servo control system to control the actuator arm as it seeks from track to track.

FIG. 1 shows a prior art disk format 2 as comprising a number of radially-spaced, concentric servo tracks 4 defined by servo wedges 6₀-6_{N} recorded around the circumference of each servo track. A plurality of concentric data tracks is defined relative to the servo tracks 4, wherein the data tracks may have the same or a different radial density (e.g., tracks per inch (TPI)) than the servo tracks 4. Each servo wedge 6ᵢ comprises a preamble 8 for storing a periodic pattern, which enables proper gain adjustment and timing synchronization of the read signal, and a sync mark 10 for storing a special pattern used to symbol synchronize to a servo data field 12. The servo data field 12 stores coarse head positioning information, such as a servo track address, used to position the head over a target data track during a seek operation. Each servo wedge (e.g., servo wedge 6₄) further comprises groups of phase-based servo bursts 14 (e.g., N and Q servo bursts), which are recorded with a predetermined phase relative to one another and relative to the servo track centerlines.

The coarse head position information is processed to position a head over a target data track during a seek operation, and the servo bursts 14 provide fine head position information used for centerline tracking while accessing a data track during write/read operations. A position error signal (PES) is generated by reading the servo bursts 14, wherein the PES represents a measured position of the head relative to a centerline of a target servo track. A servo controller processes the PES to generate a control signal applied to one or more head actuators in order to actuate the head radially over the disk in a direction that reduces the PES. The one or more head actuators may comprise a voice coil motor, as well as one or more fine control actuators such as milliactuators or microactuators, in some examples.

### SUMMARY

Various examples disclosed herein provide data storage devices such as hard disk drives with control circuitry configured to perform novel and inventive methods of deferred decoding of analog read signals. In various examples, control circuitry of this disclosure is inventively configured to provide for decoding of analog read signals from a previous read operation concurrently with performing a seek operation associated with a next read operation by intelligently routing analog read signal data to one of a first buffer or a second buffer prior to decoding. In this manner, implementations enable achieving performance advantages that are typically associated with multiple channel disk drives while also minimizing power consumption and an amount of chip area occupied by the channel.

Disk drives may be configured to read data sectors from multiple tracks of one or more disk surfaces simultaneously using multiple read elements to achieve an increased read data rate compared to disk drives that read data sectors from only a single track at a time using a single read element. Disk drives that use multiple read elements to simultaneously read data sectors from multiple tracks may be referred to as multi-access disk drives. Single channel multi-access disk drives include a single channel that digitally decodes the analog data obtained using multiple read elements. Multiple channel multi-access disk drives include multiple channels that digitally decode the analog data obtained using the multiple read elements. Multiple channel multi-access disk drives may achieve a higher read data rate compared to single channel multi-access disk drives, but they have an increased amount of channel circuitry in the system-on-chip (SoC) compared to a single channel disk drive and, thus, come at a higher cost and use more power than a single channel disk drive. Single channel multi-access disk drives, on the other hand, cost less and consume less power than multiple channel multi-access disk drives, but they have lower read data rates compared to a multiple channel multi-access disk drive because the read data rate is constrained by the bandwidth (e.g., throughput capacity) of the single channel.

Various examples of the present disclosure provide disk drives having minimized channel area and power consumption that utilize time under seek (or seek and latency) of a next read operation to decode analog data that was obtained during a previous read operation. Implementations of the present disclosure may be used with any type of disk drive, including but not limited to multi-access disk drives, to reduce the channel area and power consumption of the SoC included in the disk drive. In various embodiments, a disk drive includes a channel that is configured to decode data obtained during a read operation, a first buffer and a second buffer that are configured to store data that is to be decoded using the channel, and control circuitry that is configured to select a routing option from multiple different routing options for routing data to the first buffer or the second buffer prior to decoding. By intelligently routing data to one of the first buffer or the second buffer prior to decoding, a disk drive in accordance with aspects of the present disclosure may be configured to read data during a first read operation, begin decoding that data during the first read operation, and continue decoding that data during a seek time (or a seek time and a latency time) of a second read operation immediately following the first read operation. By providing the ability to continue decoding data from a previous operation during the seek (or the seek and latency) of a next operation, embodiments enable starting the next operation sooner, thereby improving the performance of the disk drive. In this manner, implementations of the present disclosure may be used to provide performance advantages that are typically associated with multiple channel multi-access disk drives while also realizing the cost and power savings by enabling using a channel having a throughput capacity that is less than a rate at which data is read and provided for decoding.

Various illustrative aspects are directed to a data storage device, comprising one or more disks; an actuator mechanism configured to position one or more heads proximate to a corresponding disk surface of a corresponding disk of the one or more disks; and one or more processing devices. The one or more processing devices, individually or in combination, are configured to: perform a read operation comprising reading data from one or more tracks on the one or more corresponding disk surfaces; store digitized analog read signals associated with the read operation in one or more buffers; and decode the digitized analog read signals following the storing the digitized analog read signals.

Various illustrative aspects are directed to a method comprising: performing a read operation in a data storage device, the read operation comprising reading data from one or more tracks on one or more corresponding disk surfaces in the data storage device; storing digitized analog read signals associated with the read operation in one or more buffers; and decoding the digitized analog read signals following the storing the digitized analog read signals.

Various illustrative aspects are directed to one or more processing devices comprising: means for performing a read operation in a data storage device, the read operation comprising reading data from one or more tracks on one or more corresponding disk surfaces in the data storage device; means for storing digitized analog read signals associated with the read operation in one or more buffers; and means for decoding the digitized analog read signals following the storing the digitized analog read signals.

Various further aspects are depicted in the accompanying figures and described below and will be further apparent based thereon.

### BRIEF DESCRIPTION OF THE DRAWINGS

Various features and advantages of the technology of the present disclosure will be apparent from the following description of particular examples of those technologies and as illustrated in the accompanying drawings. The drawings are not necessarily to scale; the emphasis instead is placed on illustrating the principles of the technological concepts. In the drawings, like reference characters may refer to the same parts throughout the different views. The drawings depict only illustrative examples of the present disclosure and are not limiting in scope.

FIG. 1 shows a prior art disk format comprising a number of radially-spaced, concentric servo tracks defined by servo wedges recorded around the circumference of each servo track.

FIGS. 2A and 2B illustrate conceptual block diagrams of a top view and a side view of a data storage device in the form of a disk drive, in accordance with aspects of the present disclosure.

FIG. 2C depicts a flowchart for an example method that control circuitry of a disk drive may perform or execute in controlling the operations of the disk drive, in accordance with aspects of the present disclosure.

FIG. 3 depicts a conceptual block diagram of control circuitry of FIG. 2A in accordance with aspects of the present disclosure.

FIG. 4 depicts a comparison of exemplary times involved in performing successive read operations in different types of multi-access disk drives in accordance with various aspects of the present disclosure.

FIG. 5 depicts comparative sectors per track for various disk drives in accordance with various aspects of the present disclosure.

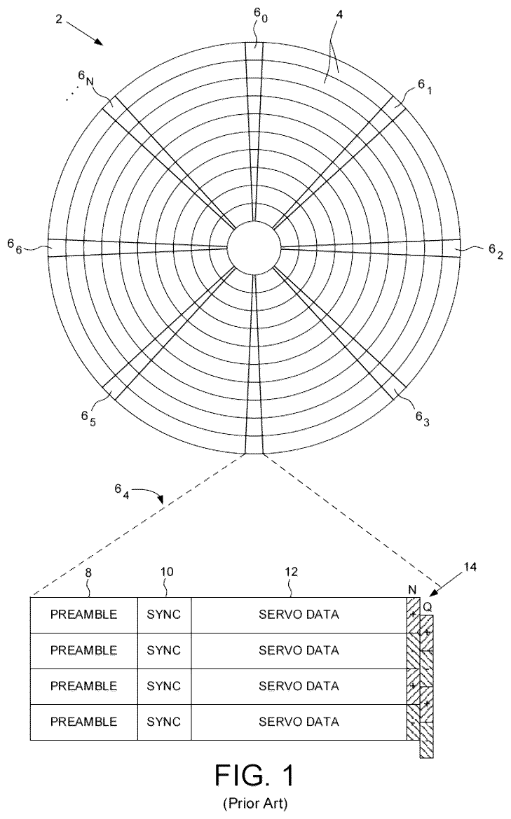

### DETAILED DESCRIPTION

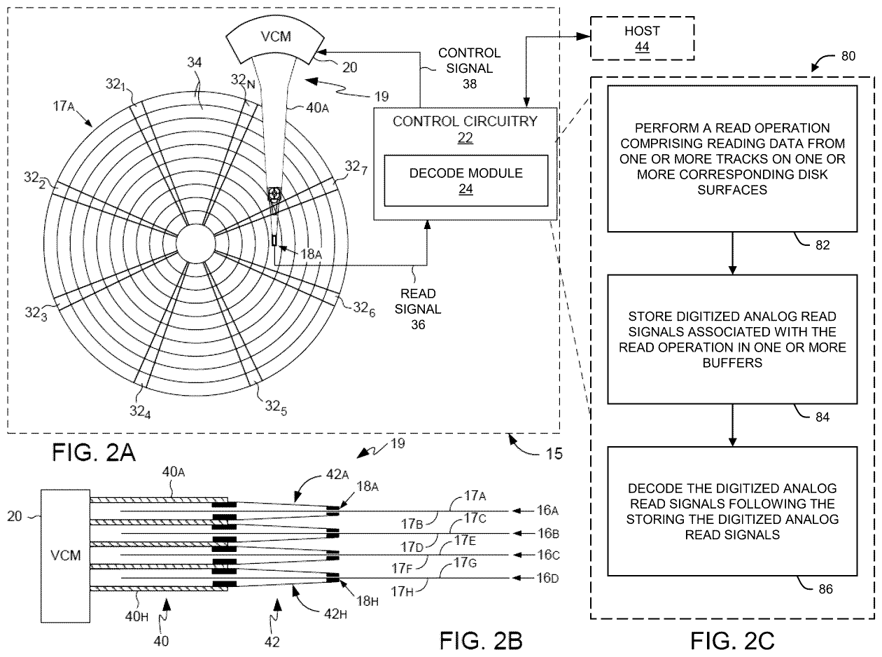

FIGS. 2A and 2B illustrate conceptual block diagrams of a top view and a side view of a data storage device in the form of a disk drive 15, in accordance with aspects of the present disclosure. Disk drive 15 comprises control circuitry 22, an actuator arm assembly 19, and a plurality of hard disks 16A, 16B, 16C, 16D (“hard disks 16”). FIG. 2C depicts a flowchart for an example method 80 that decode module 24 of control circuitry 22 may perform or execute in controlling the operations of disk drive 15, in accordance with aspects of the present disclosure, including deferred decoding of analog read signals in accordance with aspects of the present disclosure.

Actuator arm assembly 19 comprises a primary actuator 20 (e.g., a VCM) and a number of actuator arms 40 (e.g., topmost actuator arm 40A, as seen in the top and side views of FIGS. 2A and 2B). Each of actuator arms 40 comprises a suspension assembly 42 at a distal end thereof (e.g., topmost suspension assembly 42A comprised in topmost actuator arm 40A, in the view of FIGS. 2A and 2B). Each suspension assembly 42 may comprise one or more additional fine actuators, in some examples.

Each of actuator arms 40 is configured to suspend a read/write head 18 in close proximity over a corresponding disk surface 17 (e.g., read/write head 18A suspended by topmost actuator arm 40A over topmost corresponding disk surface 17A and read/write head 18H suspended by lowest actuator arm 40H over lowest corresponding disk surface 17H). As used herein, a head 18 may be said to operate “above” or “over” a corresponding disk surface 17 in terms that define the local frame of reference in accordance therewith. Other examples may include any of a wide variety of other numbers of hard disks and disk surfaces, and other numbers of actuator arm assemblies, primary actuators, and fine actuators besides the one actuator arm assembly 19 and the one actuator in the form of VCM of primary actuator 20 in the example of FIGS. 2A and 2B, for example.

In various examples, disk drive 15 may be considered to perform or execute functions, tasks, processes, methods, and/or techniques, including aspects of example method 80, in terms of its control circuitry 22 performing or executing such functions, tasks, processes, methods, and/or techniques. Control circuitry 22 may comprise and/or take the form of one or more driver devices and/or one or more other processing devices of any type, and may implement or perform functions, tasks, processes, methods, or techniques by executing computer-readable instructions of software code or firmware code, on hardware structure configured for executing such software code or firmware code, in various examples. Control circuitry 22 may also implement or perform functions, tasks, processes, methods, or techniques by its hardware circuitry implementing or performing such functions, tasks, processes, methods, or techniques by the hardware structure in itself, without any operation of software, in various examples. Control circuitry 22 may be operatively in communicative and/or control connection or coupling with a host 44, which may include any external processing, computing, and/or data management entity, such as a computing device, a storage area network, a data center, a cloud computing resource of any kind, and/or any other kind of host, in various examples.

Control circuitry 22 may comprise one or more processing devices that constitute device drivers, specially configured for driving and operating certain devices, and one or more modules. Such device drivers may comprise one or more head drivers, configured for driving and operating heads 18. Device drivers may be configured as one or more integrated components of one or more larger-scale circuits, such as one or more power large-scale integrated circuit (PLSI) chips or circuits, and/or as part of control circuitry 22, in various examples. Device drivers may also be configured as one or more components in other large-scale integrated circuits such as SoC circuits, or as more or less stand-alone circuits, which may be operably coupled to other components of control circuitry 22, in various examples.

Primary actuator 20 may perform primary, macroscopic actuation of a plurality of actuator arms 40, each of which may suspend one of heads 18 over and proximate to corresponding disk surfaces 17 of disks 16. The positions of heads 18, e.g., heads 18A and 18H, are indicated in FIG. 2A, although heads 18 are generally positioned very close to the disk surfaces and are too small to be visible if depicted to scale in FIGS. 2A and 2B.

Example disk drive 15 of FIGS. 2A and 2B comprises four hard disks 16. Other examples may comprise any number of disks, such as just one disk, two disks, three disks, or five or more disks, or ten or eleven or more disks. Hard disks 16 may also be known as platters, and their disk surfaces may also be referred to as media, or media surfaces. The four hard disks 16 comprise eight disk surfaces 17A, 17B, 17C, 17D, 17E, 17F, 17G, and 17H (“disk surfaces 17”), with one disk surface 17 on each side of each hard disk 16, in this illustrative example. Actuator assembly 19 suspends heads 18 of each actuator arm 40 over and proximate to a corresponding disk surface 17, enabling each of heads 18 to write control features and data to, and read control features and data from, its respective, proximate disk surface 17. In this sense, each head 18 of each actuator arm 40 interacts with a corresponding disk surface 17. Each head 18 may include a write element including an inductive write coil. Control circuitry 22 may be configured to write data to a corresponding disk surface 17 by modulating a write current in the inductive write coil to record magnetic transitions onto the corresponding disk surface 17 in a process referred to as saturation recording. Each head 18 may include a read element (e.g., magnetoresistive (MR) element) configured to sense magnetic transitions in a corresponding disk surface 17 and output an analog read signal based on the magnetic transitions. Each head 18 may include one or more read elements.

The term “disk surface” may be understood to have the ordinary meaning it has to persons skilled in the applicable engineering fields of art. The term “disk surface” may be understood to comprise both the very outer surface layer of a disk as well as a volume of disk matter beneath the outer surface layer, which may be considered in terms of atomic depth, or (in a simplified model) the number of atoms deep from the surface layer of atoms in which the matter is susceptible of physically interacting with the heads. The term “disk surface” may comprise the portion of matter of the disk that is susceptible of interacting with a read/write head in disk drive operations, such as control write operations, control read operations, data write operations, and data read operations, for example.

In the embodiment of FIGS. 2A and 2B, each disk surface, e.g., disk surface 17A as shown in FIG. 2A, comprises a plurality of control features. The control features comprise servo wedges 32₁-32_{N}, which define a plurality of servo tracks 34, wherein data tracks are defined relative to the servo tracks 34, and which may be at the same or different radial density. Control circuitry 22 processes a read signal 36 emanating from the respective head, e.g., head 18A, to read from disk surface 17A, to demodulate the servo wedges 32₁-32_{N} and generate a position error signal (PES) representing an error between the actual position of the head and a target position relative to a target track. A servo control system in the control circuitry 22 filters the PES from the servo wedges using a suitable compensation filter to generate a control signal 38 applied to actuator arm assembly 19, including VCM of primary actuator 20 which rotates actuator arm assembly 19 about an axial pivot in order to perform primary actuation of the corresponding heads 18 radially over the disk surfaces 17 in a direction that reduces the PES, as well as to control any fine actuators, in various examples. Control circuitry 22 may also apply control signals to and receive sensor signals from heads 18 and/or any of various components of disk drive 15, in various examples.

In the example of FIGS. 2A and 2B, actuator arm assembly 19 rotates actuator arms 40 about a common pivot. In another example, a first actuator arm assembly and/or VCM and a second actuator arm assembly and/or VCM, or other types of primary actuators, may each be configured to actuate respective actuator arm assemblies or sets of multi-actuator arms about separate pivots, for example, mounted at different circumferential locations about the disks. In some examples, each of the two actuator arm assemblies may control half of the heads and write to and read from half of the disk surfaces. In some examples, each of the actuator arm assemblies may be addressable by host 44 as a separate logical data storage unit. Other examples may employ more than two actuator arm assemblies or primary actuators or multi-actuators, which may be actuated about a common pivot, or which may be comprised in multiple multi-actuators mounted at different circumferential locations about the disks. Actuator arm assembly 19 and/or any of these other examples may thus constitute and/or comprise an actuator mechanism, in various examples. An actuator mechanism such as actuator arm assembly 19 may thus be configured to position heads 18, including a selected head among one or more heads 18, proximate to a corresponding disk surface 17 among the one or more disks 16.

In executing example method 80 of FIG. 2C (aspects of which will also be further explained below with reference to the further figures), control circuitry 22 may issue one or more commands to other components of disk drive 15, receive information from one or more other components of disk drive 15, and/or perform one or more internal operations, such as generating one or more driver currents for outputting to system components of disk drive 15. In a particular example, decode module 24 of control circuitry 22 may perform a read operation comprising reading data from one or more tracks on the one or more corresponding disk surfaces (82). Decode module 24 may further store digitized analog read signals associated with the read operation in one or more buffers (84). Decode module 24 may further decode the digitized analog read signals following the storing the digitized analog read signals (86). Control circuitry 22, including decode module 24, may further perform additional actions, methods, and techniques, in accordance with various aspects including as further described herein.

The term “decode module 24” as used herein may refer to any hardware, firmware, software, and/or combination thereof, comprised in control circuitry 22 of disk drive 15, which implements, embodies, or engages in any of the structures or functions ascribed herein to decode module 24 or to any other of the novel and inventive aspects of the present disclosure. Decode module 24 may constitute any hardware, firmware, software, and/or any other elements of control circuitry 22 for performing deferred decoding of analog read signals, and performing other techniques and methods as described herein.

In various examples of the present disclosure, disk drive 15 comprises a multi-access disk drive that is configured to use multiple read elements in one or more heads 18 to simultaneously read data stored in multiple tracks on one or more disk surfaces 17. In one example, disk drive 15 uses two read elements to simultaneously read data from two tracks referred to as paired tracks. The paired tracks may be on a same disk surface, e.g., both of the paired tracks on disk surface 17A. Alternatively, the paired tracks may be on different disk surfaces, e.g., one of the paired tracks on disk surface 17A and another one of the paired tracks on disk surface 17B. In examples in which the paired tracks are on a same disk surface, the two read elements that read data from the paired tracks may be in a same head or separate heads. In examples in which the two read elements are in a same head, the two read elements may be spaced apart from one another in a down-track direction and in a radial direction to substantially maximize readback performance. In examples in which the two read elements are in separate heads, the separate heads may be independently controllable relative to the disk surface and one another (e.g., independent heads). In embodiments, control circuitry 22 decodes analog data that is simultaneously read from paired tracks and outputs the decoded data in a single stream (e.g., a single LBA (logical block address) stream) that may be communicated to host 44. In this manner, disk drive 15 may provide an increased read data rate compared to disk drives that read data from only a single track at a time using a single read element.

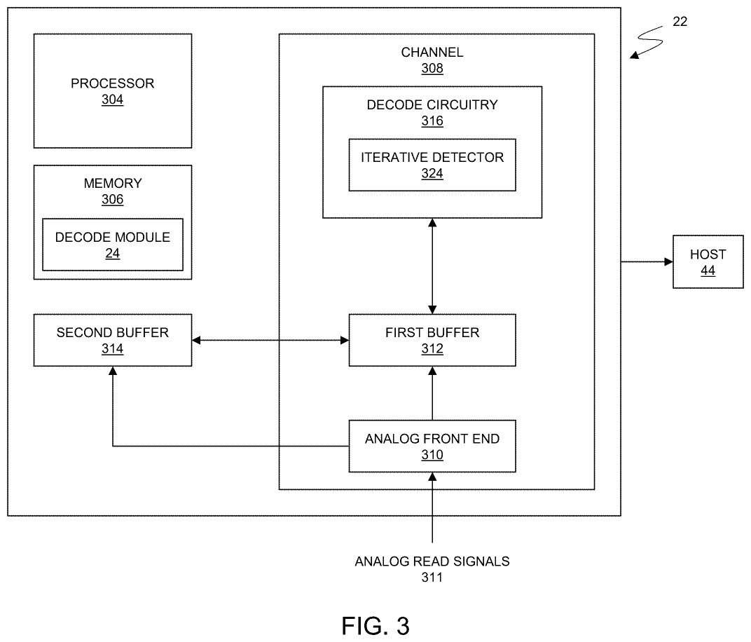

FIG. 3 illustrates a conceptual block diagram of control circuitry 22 of FIG. 2A in accordance with aspects of the present disclosure. In various embodiments, control circuitry 22 includes processor 304, memory 306, and channel 308. Control circuitry 22 may include other elements not shown in FIG. 3.

Processor 304 may include any type of conventional processor, microprocessor, or the like that interprets and executes instructions. Memory 306 may include a random-access memory (RAM) or another type of dynamic storage device that stores information and instructions for execution by processor 304 and/or a read only memory (ROM) or another type of static storage device that stores static information and instructions for use by processor 304 and/or any suitable storage element, such as a system portion of a hard disk medium or a solid-state storage element. Memory 306 may be configured to store controller firmware comprising instructions that include one or more modules or sub-modules for specific data storage device operations, and processor 304 may execute those instructions. In various examples, decode module 24 may be stored in memory 306 for execution by processor 304.

Channel 308 may comprise a read/write channel (also referred to as an input/output (I/O) channel) including one or more specialized circuits configured for processing binary data to be written to disk surfaces 17 of FIG. 2A using an analog write signal and processing back into binary data an analog read signal obtained by reading data stored on the disk surfaces 17. For example, channel 308 may include a write path comprised of various data scramblers, run length limited (RLL) encoders, iterative error correction code (ECC) encoders, pre-compensation circuits, and other data or signal processing components. Channel 308 may include a read path comprised of various amplifiers, filters, equalizers, analog-to-digital converters (ADCs), soft information detectors, iterative ECC decoders, and other data or signal processing components. The write channel components may comprise a write channel circuit, and the read channel components may comprise a read channel circuit, though the circuits may share some components. Channel 308 may provide the analog write signal to and receive the analog read signal from a preamplifier (also called a preamp or preamplifier circuit), which controls and amplifies signals to and from heads 18. Binary data for recording to the storage medium may be received by channel 308 from controller firmware, and decoded data from channel 308 may be passed to controller firmware and/or directed to memory for communication to host 44.

In some configurations, channel 308 may include an analog front end 310 configured to receive analog read signals 311 from read elements in one or more heads 18 and convert them into digitized analog read signals for processing by other components of channel 308. In embodiments, analog front end 310 performs initial conditioning and sampling of the analog read signals that are output by read elements. For example, analog front end 310 may include an ADC that receives an analog read signal from a read element and that generates a digitized analog read signal that may be routed to first buffer 312 or second buffer 314 for storing prior to decoding. A respective analog read signal received by analog front end 310 may be generated by a read element in one of heads 18 based on reading data in a respective sector of a corresponding disk surface 17. In this manner, a respective digitized analog read signal output by analog front end 310 corresponds to the data in a respective sector after conditioning and sampling by analog front end 310 and prior to decoding by decode circuitry 316. In some configurations, analog front end 310 may include a timing circuit and one or more filters, equalizers, and/or other signal conditioning components for generating the digitized analog read signal. In some configurations, control circuitry 22 may include a preamp operatively connected between the read element and the analog front end such that the ADC receives analog read signals from a read element via the preamp. In some configurations, analog front end 310 may rely on filtering, equalization, and other analog signal conditioning to be carried out by the preamp.

In embodiments, a read channel circuit in channel 308 includes decode circuitry 316 that is configured to decode the digitized analog read signals generated by analog front end 310. In one example, decode circuitry 316 includes an iterative detector 324 that is configured to receive digitized analog read signals from first buffer 312 and use iterative bit detection and ECC processing to decode the digitized analog read signals into decoded data (e.g., digital data) for further processing by controller firmware and/or communication to host 44. In this example, iterative detector 324 may include one or more bit detectors, such as soft output Viterbi algorithm (SOVA) detectors, and one or more iterative decoders, such as low density parity check (LDPC) decoders operating on multi-bit encoded symbols to decode each sector of data received by channel 308. Other types of iterative detector 324 may be used.

In embodiments, control circuitry 22 is configured to create a single stream of decoded data (e.g., digital data) based on a read operation performed using a set of paired tracks. Each sector of data that is read during the read operation may have a tag (e.g., identifier) associated with it, and control circuitry 22 may use these tags to arrange the data in a particular order to create the single stream of decoded data. The stream of decoded data (e.g., digital data) may be communicated to host 44 as the response to a read command received from host 44.

In various embodiments, control circuitry 22 utilizes first buffer 312 or second buffer 314 to store digitized analog read signals generated by the analog front end 310 prior to decoding the digitized analog read signals using decode circuitry 316. First buffer 312 and second buffer 314 may comprise different types of memory that have different characteristics such as speed. In various embodiments, first buffer 312 comprises a first type of memory, and second buffer 314 comprises a second type of memory, where the first type of memory is faster than the second type of memory. For example, first buffer 312 may comprise static random-access memory (SRAM), and second buffer 314 may comprise dynamic random-access memory (DRAM). In various embodiments, first buffer 312 is included in (e.g., integrated as part of) channel 308, and second buffer 314 is separate from channel 308 and operatively connected to channel 308 via a bus. Second buffer 314 may also be outside of control circuitry 22 and connected to control circuitry 22 by a bus. In various examples, digitized analog read signals may be transferred from first buffer 312 to second buffer 314, or from second buffer 314 to first buffer 312, using direct memory access (DMA).

With continued reference to FIG. 3, and in accordance with aspects of the present disclosure, decode module 24 of control circuitry 22 is configured to intelligently route digitized analog read signals that are output by analog front end 310 to one of first buffer 312 or second buffer 314 to provide for deferred decoding of data from a previous read operation during a seek operation of a next read operation immediately following the previous read operation. A seek operation associated with a read operation may include both seek time and latency time. As used herein, seek time refers to an amount of time that a head of the disk drive seeks (e.g., moves radially relative to the disk) to a target track associated with the read operation. As used herein, latency time refers to an amount of time, after the seek time, that the head tracks over the target track to arrive at a target data sector (e.g., the data sector at the beginning of the read operation). Latency time may also be referred to as rotate-to-target time. Together, seek time and latency time may be referred to as seek and latency time. By decoding the data associated with a previous operation during the seek operation of a next read operation, implementations of the present disclosure utilize the channel at times when the channel is normally idle. In this manner, implementations of the present disclosure may enable performance advantages that are typically associated with multiple channel multi-access disk drives while also minimizing area and power consumption associated with channel 308.

In a first exemplary mode of operation, decode module 24 routes all digitized analog read signals output by analog front end 310 directly to second buffer 314 for temporary storing in second buffer 314 prior to decoding by decode circuitry 316. In this mode, decode module 24 moves one or more digitized analog read signals from second buffer 314 to first buffer 312 when space is available in first buffer 312. In this mode, decode circuitry 316 obtains ones of the digitized analog read signals stored in first buffer 312 and decodes these using iterative detector 324. As various digitized analog read signals obtained from first buffer 312 are decoded in this manner, storage space in first buffer 312 becomes available, and decode module 24 moves other digitized analog read signals from second buffer 314 to first buffer 312 into this available storage space. Storing digitized analog read signals in first buffer 312 and second buffer 314 in this manner enables decoding the data associated with a previous read operation during the seek time (or seek and latency time) of a next read operation, which improves performance while minimizing channel area and power.

In a second exemplary mode of operation, decode module 24 routes digitized analog read signals output by analog front end 310 directly to first buffer 312 until first buffer 312 is full, and then routes digitized analog read signals output by analog front end 310 directly to second buffer 314 based on first buffer 312 being full. In this mode, decode circuitry 316 obtains ones of the digitized analog read signals stored in first buffer 312 and decodes these using iterative detector 324. As various digitized analog read signals obtained from first buffer 312 are decoded in this manner, storage space in first buffer 312 becomes available, and decode module 24 moves other digitized analog read signals from second buffer 314 to first buffer 312 into this available storage space. In this mode, if all digitized analog read signals have been moved from second buffer 314 to first buffer 312 and free space exists in first buffer 312, then decode module 24 may again route digitized analog read signals from analog front end 310 directly to first buffer 312 for storing prior to decoding. Storing digitized analog read signals in first buffer 312 and/or second buffer 314 in this manner enables decoding the data associated with a previous read operation during the seek time (or seek and latency time) of a next read operation, which improves performance while minimizing channel area and power.

In an example of the second mode, when data associated with a particular read operation is relatively fast to decode (e.g., the decoding does not require many iterations in iterative detector 324), decode circuitry 316 may decode the data at a rate that causes free space to become available in first buffer 312 faster than digitized analog read signals are being output by analog front end 310. In this exemplary situation, and for this particular read operation, decode module 24 need not route any of the digitized analog read signals from analog front end 310 to second buffer 314.

In a third exemplary mode of operation, decode module 24 routes respective ones of the digitized analog read signals output by analog front end 310 to first buffer 312 or second buffer 314, for storing prior to decoding, based on one or more metrics associated with the respective ones of the analog read signals. In embodiments, the one or more metrics comprise one or more qualitative metrics associated with a respective analog read signal from which a respective one of the digitized analog read signals was created. An example of one such metric is signal to noise ratio (SNR) associated with the analog read signal, although other metrics may be used. For example, an SNR value above a predefined threshold value may be used to indicate that an analog read signal will be relatively fast to decode, and an SNR value below the predefined threshold value may be used to indicate that an analog read signal will be relatively slow to decode. In this example, based on the one or more metrics indicating that a respective one of the digitized analog read signals will be relatively fast to decode, and based on free space being available in first buffer 312, decode module 24 may route this respective one of the digitized analog read signals directly to first buffer 312 from analog front end 310. In this example, based on the one or more metrics indicating that a respective one of the digitized analog read signals will be relatively slow to decode, decode module 24 may route this respective one of the digitized analog read signals directly to second buffer 314 from analog front end 310. In this example, based on the one or more metrics indicating that a respective one of the digitized analog read signals will be relatively fast to decode, and based on there not being sufficient free space is available in first buffer 312, decode module 24 may route this respective one of the digitized analog read signals directly to second buffer 314 from analog front end 310. In this example, when second buffer 314 contains at least one digitized analog read signal that will be relatively fast to decode and at least one digitized analog read signal that will be relatively slow to decode, then when space becomes available in first buffer 312, decode module 24 may choose the at least one digitized analog read signal that will be relatively fast to decode over the at least one digitized analog read signal that will be relatively slow to decode for moving to first buffer 312. In this example, decode module 24 may move one or more digitized analog read signals that will be relatively slow to decode from second buffer 314 to first buffer 312 based on available storge space in first buffer 312 exceeding a predefined threshold and/or to avoid a bottleneck. Storing digitized analog read signals in first buffer 312 and second buffer 314 in this manner enables decoding the data associated with a previous read operation during the seek time (or seek and latency time) of a next read operation, which improves performance while minimizing channel area and power.

In a fourth exemplary mode of operation, decode module 24 stores a respective one of the digitized analog read signals in first buffer 312 after attempting to decode the respective one of the digitized analog read signals in decode circuitry 316 and based on one or more correction metrics associated with the respective one of the digitized analog read signals. This fourth mode may be used in conjunction with any of the first, second, and third modes described above. In the fourth mode, decode circuitry 316 may determine one or more correction metrics associated with a respective one of the digitized analog read signals obtained from first buffer 312 when decode circuitry 316 attempts to decode the respective one of the digitized analog read signals. In embodiments, the correction metrics may include, but are not limited to, one or more of: number of bit errors detected by an error correction code; a depth of error recovery procedures needed to recover the data; and a time needed to recover the data. In embodiments, based on decode circuitry 316 determining that any one or more of these metrics exceeds a respective predefined threshold value, decode module 24 may move the respective one of the digitized analog read signals out of decode circuitry 316 and back into second buffer 314 to await decoding at a later time, e.g., when more resources are available in decode circuitry 316.

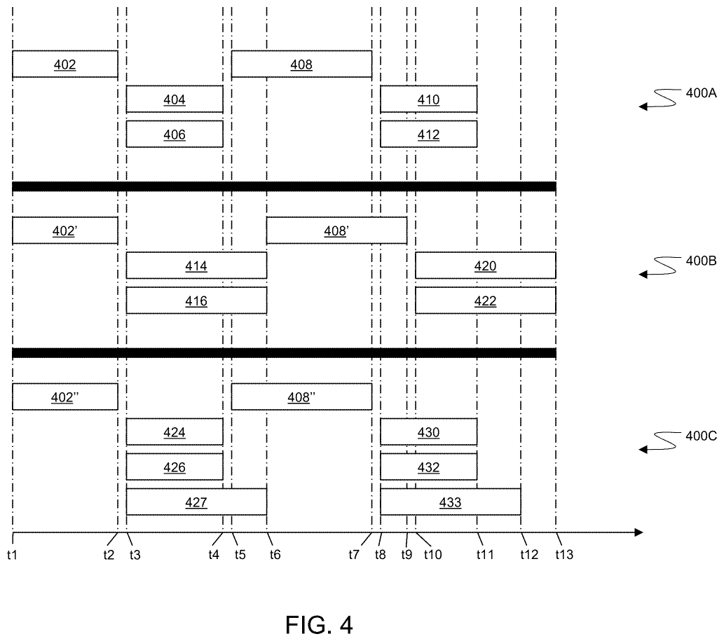

FIG. 4 shows a comparison of exemplary times involved in performing successive read operations in different types of multi-access disk drives. The horizontal axis in FIG. 4 represents time.

In FIG. 4, example 400A shows various times associated with performing a first read operation and a second read operation in a first conventional multi-access disk drive, example 400B shows various times associated with performing the same first read operation and the same second read operation in a second conventional multi-access disk drive, and example 400C shows various times associated with performing the same first read operation and the same second read operation in a multi-access disk drive in accordance with aspects of the present disclosure.

In example 400A, bar 402 represents a seek and latency time associated with the first read operation performed in the first conventional multi-access disk drive. In this example, the first conventional multi-access disk drive comprises a multiple channel multi-access disk drive that includes two read elements that simultaneously read data from two tracks and two channels that decode the data from the two read elements. In this example, the first read operation is associated with a first set of paired tracks, and the seek and latency time associated with the first read operation comprises a time associated with positioning one or more heads in the disk drive relative to the first set of paired tracks. In this example, the seek and latency time associated with the first read operation begins at time t1 and ends at time t2. Continuing this example, bar 404 represents a time associated with reading data from a first one of the paired tracks during the first read operation (e.g., using a first read element) and decoding that data using a first channel, and bar 406 represents a time associated with reading data from a second one of the paired tracks during the first read operation (e.g., using a second read element) and decoding that data using a second channel. In this example, the reading and decoding associated with the first read operation begins at time t3 and ends at time t4. Continuing this example, bar 408 represents a seek and latency time associated with positioning the one or more heads relative to a second set of paired tracks associated with a second read operation, immediately following the first read operation, in the first conventional multi-access disk drive. Bar 410 represents a time associated with reading data from a first one of the paired tracks during the second read operation and decoding that data using the first channel, and bar 412 represents a time associated with reading data from a second one of the paired tracks during the second read operation and decoding that data using the second channel. In this example, the seek and latency time associated with the second read operation begins at time t5 and ends at time t7, and the reading and decoding associated with the second read operation begins at time t8 and ends at time t11.

With continued reference to FIG. 4, and in example 400B, bar 402′ represents a seek and latency time associated with performing the same first read operation (i.e., the same as in the example 400A) in a second conventional multi-access disk drive. In this example, the second conventional multi-access disk drive comprises a single channel multi-access disk drive that includes two read elements that simultaneously read data from two tracks and one channel that decodes the data from the two read elements. Continuing this example, bar 414 represents a time associated with reading data from a first one of the paired tracks during the first read operation (e.g., using a first read element) and decoding that data using the one channel, and bar 416 represents a time associated with reading data from a second one of the paired tracks during the first read operation (e.g., using a second read element) and decoding that data using the one channel.

Continuing example 400B, bar 408′ represents the seek and latency time associated with the performing the same second read operation (i.e., the same as in example 400A), immediately following the first read operation, in the second conventional multi-access disk drive. Bar 420 represents a time associated with reading data from a first one of the paired tracks during the second read operation and decoding that data using the one channel, and bar 422 represents a time associated with reading data from a second one of the paired tracks during the second read operation and decoding that data using the one channel.

As is evident in FIG. 4, decoding the data associated with the first read operation in the second conventional multi-access disk drive in example 400B (e.g., blocks 414 and 416) takes more time than decoding the same data associated with the same first read operation in the first conventional multi-access disk drive in example 400A (e.g., blocks 404 and 406). This is because the two channels in the first conventional multi-access disk drive decode more data faster than the one channel in the second conventional multi-access disk drive. This results in the second conventional multi-access disk drive requiring more time to complete the first read operation before it can begin the second read operation, as evidenced by the second conventional multi-access disk drive beginning the second read operation at time t6 in example 400B compared to the first conventional multi-access disk drive beginning the second read operation at time t5 in example 400A. Examples 400A and 400B illustrate a tradeoff between performance and cost. The first conventional multi-access disk drive in example 400A exhibits better performance because it begins the second read operation sooner than the second conventional multi-access disk drive in example 400B. However, the second conventional multi-access disk drive in example 400B has lower costs in terms of SoC area and power because it has less channel circuitry than the first conventional multi-access disk drive in example 400A.

With continued reference to FIG. 4, and in example 400C, bar 402″ represents a seek and latency time associated with performing the same first read operation (i.e., the same as in examples 400A and 400B) in an exemplary multi-access disk drive according to aspects of the present disclosure. In this example, the multi-access disk drive according to aspects of the present disclosure comprises a single channel multi-access disk drive that includes two read elements that simultaneously read data from two tracks and one channel that decodes the data from the two read elements. Continuing this example, bar 424 represents a time associated with reading data from a first one of the paired tracks during the first read operation (e.g., using a first read element), bar 426 represents a time associated with reading data from a second one of the paired tracks during the first read operation (e.g., using a second read element), and bar 427 represents a time associated with decoding the data read from the paired tracks during the first read operation.

Continuing example 400B, bar 408″ represents the seek and latency time associated with the performing the same second read operation (i.e., the same as in examples 400A and 400B), immediately following the first read operation, in the exemplary multi-access disk drive according to aspects of the present disclosure. Bar 430 represents a time associated with reading data from a first one of the paired tracks during the first read operation (e.g., using a first read element), bar 432 represents a time associated with reading data from a second one of the paired tracks during the first read operation (e.g., using a second read element), and bar 433 represents a time associated with decoding the data read from the paired tracks during the first read operation.

As illustrated in FIG. 4, the exemplary multi-access disk drive according to aspects of the present disclosure continues decoding the data associated with the first read operation during the seek and latency time of the second read operation that immediately follows the first read operation. In this manner, the exemplary multi-access disk drive according to aspects of the present disclosure begins the second read operation while still decoding the data read during the first read operation, which enables beginning the second read operation sooner compared to the example 400B. In this manner, multi-access disk drives according to aspects of the present disclosure enable performance associated with multiple channel multiple access drives (e.g., similar to example 400A) while minimizing cost and power by including fewer channels (e.g., similar to example 400B).

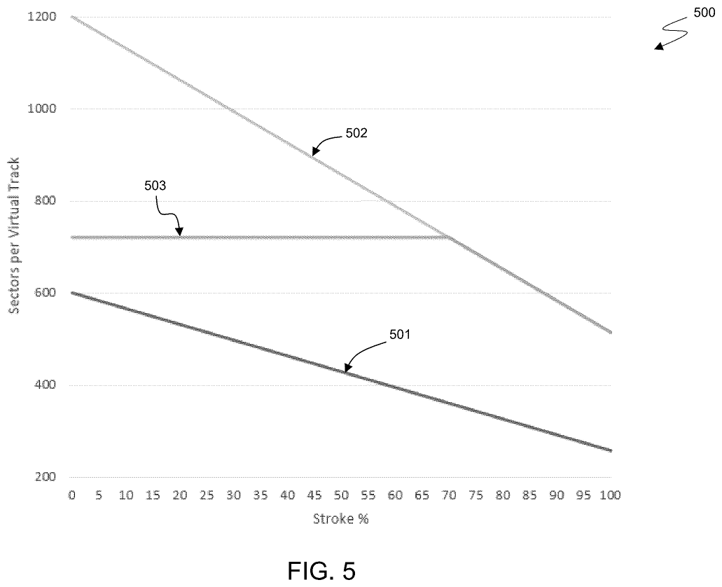

FIG. 5 illustrates comparative sectors per virtual track (physical or virtual track as applicable), shown on the y-axis, from outer diameter to inner diameter (from left to right), shown across the x-axis, of disk surfaces 17, across conventional, multiple channel multi-access, and single channel multi-access disk drives, for otherwise comparable disk drives, as shown in graph 500. Track radius or disk position diameter may be referred to in terms of stroke, with stroke of 0 to 100% corresponding with diameter from outer diameter to inner diameter, as shown in the labeling along the x-axis. As used herein, a virtual track in a multi-access disk drive refers to a logical track that is assigned to and comprises at least a primary physical track and at least a portion of a donor physical track. The physical track and the donor track associated with a virtual track may constitute a set of paired tracks as described herein.

Line segment 501 shows sectors per track for a conventional disk drive. In this example, sectors per track go from approximately 600 at the outer diameter to approximately 260 at the inner diameter. In this conventional disk drive, the sectors per virtual track refers to sectors per physical track, as there is no distinction between virtual tracks and physical tracks.

Line segment 502 shows sectors per virtual track for a multiple channel multi-access disk drive, and in particular with a 2× multiple integer band disk drive using two read heads and two channels, in which pairs of physical tracks are logically bundled together, such that each virtual track comprises two physical tracks. In this example, sectors per track are double the sectors per track for the conventional disk drive as shown in line segment 501 and go from approximately 1,200 at the outer diameter to approximately 520 at the inner diameter.

Line segment 503 shows sectors per virtual track for an example single channel multi-access disk drive. As shown in line segment 503, in various examples the single channel multi-access disk drive has a constant number of sectors per virtual track across a substantial proportion of track radii between the outer diameter and inner diameter of disks 16. This example is referred to as 1.2× because it assigns a number of sectors per virtual track equal to 1.2 times the maximum number of sectors per physical track, at the outer diameter. In this example in which the number of sectors per physical track at the outer diameter is 600, the 1.2× disk drive assigns 720 sectors per virtual track. At the outer diameter, the 1.2× disk drive assigns 20% of a donor track to the outermost, longest full primary physical track, such that that virtual track carries 120% of the bandwidth of that outermost, longest full primary physical track. Across the majority of the disk diameter in which the 1.2× disk drive implements the constant sectors per track at 720, the 1.2× disk drive assigns an ever higher proportion of a donor track beyond 20%, in proportional compensation to decreasing physical track radius, to each full primary physical track, such that each virtual track carries 120% of the capacity of the physical capacity of the outermost physical track.

Exemplary disk drives in accordance with aspects of the present disclosure are capable of reading and decoding virtual tracks having numbers of sectors per virtual track associated with line segment 502 in an analog burst mode and are capable of reading and decoding virtual tracks having numbers of sectors per virtual track associated with line segment 503 in a digital sustained mode. In this manner, exemplary disk drives in accordance with aspects of the present disclosure enable achieving performance advantages that are typically associated with multiple channel disk drives while also minimizing channel area and power consumption.

Various aspects of the present disclosure have been described thus far using the example of a multi-access disk drive that is configured to read data sectors from multiple tracks of one or more disk surfaces simultaneously using multiple read elements. However, implementations of the present disclosure are not limited to deferred decoding of analog read signals only when reading data from multiple tracks simultaneously. Instead, implementations of the present disclosure may be used in any disk drive in which the channel has a throughput capacity that is less than a rate at which data is read and provided for decoding by the channel. For example, the novel and inventive methods of deferred decoding of analog read signals described herein may be utilized with a disk drive that reads data from a single track at a rate that is faster than the rate at which the channel can decode the data from the single track. In this manner, implementations may be used to perform a method including: performing a first read operation comprising reading data from one or more tracks on one or more corresponding disk surfaces; storing digitized analog read signals associated with the first read operation in one or more buffers; and decoding the digitized analog read signals concurrently with performing a seek operation associated with a second read operation following the first read operation. Moreover, in some instances, the channel may complete (e.g., finish) decoding all the digitized analog read signals associated with a current read operation prior to the control circuitry initiating a next read operation. For example, a write operation or an idle time might immediately follow the current read operation, in which case the channel may have sufficient time to decode all the digitized analog read signals associated with the current read operation prior to a seek operation of a next read operation.

Any suitable control circuitry may be employed to implement the flow diagrams in the above examples, such as any suitable integrated circuit or circuits. For example, the control circuitry may be implemented within a read channel integrated circuit, or in a component separate from the read channel, such as a data storage controller, or certain operations described above may be performed by a read channel and others by a data storage controller. In some examples, the read channel and data storage controller may be implemented as separate integrated circuits, and in some examples, the read channel and data storage controller may be fabricated into a single integrated circuit or SoC. In some examples, the control circuitry may include a suitable preamp circuit implemented as a separate integrated circuit, integrated into the read channel or data storage controller circuit, or integrated into an SoC.

In some examples, the control circuitry may comprise a microprocessor executing instructions, the instructions being operable to cause the microprocessor to perform one or more aspects of methods, processes, or techniques shown in the flow diagrams and described with reference thereto herein. Executable instructions of this disclosure may be stored in any computer-readable medium. In some examples, executable instructions of this disclosure may be stored on a non-volatile semiconductor memory device, component, or system external to a microprocessor, or integrated with a microprocessor in an SoC. In some examples, executable instructions of this disclosure may be stored on one or more disks and read into a volatile semiconductor memory when the disk drive is powered on. In some examples, the control circuitry may comprise logic circuitry, such as state machine circuitry. In some examples, at least some of the flow diagram blocks may be implemented using analog circuitry (analog comparators, timers, etc.). In some examples, at least some of the flow diagram blocks may be implemented using digital circuitry or a combination of analog and digital circuitry.

In various examples, one or more processing devices may comprise or constitute the control circuitry as described herein and/or may perform one or more of the functions of control circuitry as described herein. In various examples, the control circuitry, or other one or more processing devices performing one or more of the functions of control circuitry as described herein, may be abstracted away from being physically proximate to the disks and disk surfaces. The control circuitry, and/or one or more device drivers thereof, and/or one or more processing devices of any other type performing one or more of the functions of control circuitry as described herein, may be part of or proximate to a rack of multiple data storage devices, or a unitary product comprising multiple data storage devices, or may be part of or proximate to one or more physical or virtual servers, or may be part of or proximate to one or more local area networks or one or more storage area networks, or may be part of or proximate to a data center, or may be hosted in one or more cloud services, in various examples.

In various examples, a disk drive may include a magnetic disk drive, an optical disk drive, a hybrid disk drive, or other types of disk drive. Some examples may include electronic devices such as computing devices, data server devices, media content storage devices, or other devices, components, or systems that may comprise the storage media and/or control circuitry as described above.

The various features and processes described above may be used independently of one another or may be combined in various ways. All possible combinations and subcombinations fall within the scope of this disclosure. Certain method, event, or process blocks may be omitted in some implementations. The methods and processes described herein are not limited to any particular sequence, and the blocks or states relating thereto can be performed in other sequences. For example, described tasks or events may be performed in an order other than that specifically disclosed, or multiple may be combined in a single block or state. The example tasks or events may be performed in serial, in parallel, or in another manner. Tasks or events may be added to or removed from the disclosed examples. The example systems and components described herein may be configured differently than described. For example, elements may be added to, removed from, or rearranged compared to the disclosed examples.

While certain example embodiments are described herein, these embodiments are presented by way of example only and do not limit the scope of the inventions disclosed herein. Thus, nothing in the foregoing description implies that any particular feature, characteristic, step, module, or block is necessary or indispensable. The novel methods and systems described herein may be embodied in a variety of other forms. Various omissions, substitutions, and changes in the form of the methods and systems described herein may be made without departing from the spirit and scope of the present disclosure.

Method 80 and other methods of this disclosure may include other steps or variations in various other embodiments. Some or all of any of method 80 and other methods of this disclosure may be performed by or embodied in hardware, and/or performed or executed by a controller, a central processing unit (CPU), a field-programmable gate array (FPGA), an SoC, a multi-processor system on chip (MPSoC), which may include both a CPU and an FPGA, and other elements together in one integrated SoC, or other processing device or computing device processing executable instructions, in controlling other associated hardware, devices, systems, or products in executing, implementing, or embodying various subject matter of the method. Steps of method 80, and other methods of this disclosure, may be performed individually or in combination by one or more processing devices. For example, in some implementations, the one or more processing devices may comprise a single processing device that performs all the steps of such a method. In some implementations, different respective ones of the one or more processing devices may perform different respective steps of such a method. For example, in some implementations, the one or more processing devices may comprise at least a first processing device that performs a first subset of the steps of such a method and at least a second processing device that performs a second subset of the steps of the method. In some implementations, one or more steps of such a method may be performed by two or more of the one or more processing devices acting in combination.

Data storage systems, devices, and methods implemented with and embodying novel advantages of the present disclosure are thus shown and described herein, in various foundational aspects and in various selected illustrative applications, architectures, techniques, and methods for implementing and embodying novel advantages of the present disclosure. Persons skilled in the relevant fields of art will be well-equipped by this disclosure with an understanding and an informed reduction to practice of a wide panoply of further applications, architectures, techniques, and methods for novel advantages, techniques, methods, processes, devices, and systems encompassed by the present disclosure and by the claims set forth below.

As used herein, the recitation of “at least one of A, B, and C” is intended to mean “either A, B, C, or any combination of A, B, and C.” The descriptions of the disclosed examples are provided to enable any person skilled in the relevant fields of art to understand how to make or use the subject matter of the present disclosure. Various modifications to these embodiments will be readily apparent to those skilled in the art based on the present disclosure, and the generic principles defined herein may be applied to other examples without departing from the spirit or scope of the disclosure. Thus, the present disclosure is not limited to the embodiments shown herein but is to be accorded the widest scope consistent with the principles and novel features disclosed herein.

The present disclosure and many of its attendant advantages will be understood by the foregoing description, and various changes may be made in the form, construction, and arrangement of the components without departing from the disclosed subject matter or without sacrificing all or any of its material advantages. The form described is merely explanatory, and the following claims encompass and include a wide range of embodiments, including a wide range of examples encompassing any such changes in the form, construction, and arrangement of the components as described herein.

While the present disclosure has been described with reference to various examples, it will be understood that these examples are illustrative and that the scope of the disclosure is not limited to them. All subject matter described herein are presented in the form of illustrative, non-limiting examples, and not as exclusive implementations, whether or not they are explicitly called out as examples as described. Many variations, modifications, and additions are possible within the scope of the examples of the disclosure. More generally, examples in accordance with the present disclosure have been described in the context of particular implementations. Functionality may be separated or combined in blocks differently in various examples of the disclosure or described with different terminology, without departing from the spirit and scope of the present disclosure and the following claims. These and other variations, modifications, additions, and improvements may fall within the scope of the disclosure as defined in the claims that follow.

What is claimed is:

1. A data storage device, comprising:
one or more disks;
one or more actuator mechanisms configured to position one or more heads proximate to one or more corresponding disk surfaces of the one or more disks; and
one or more processing devices, individually or in combination, configured to:
perform a read operation comprising reading data from one or more tracks on the one or more corresponding disk surfaces;
store digitized analog read signals associated with the read operation in one or more buffers; and
decode the digitized analog read signals following the storing the digitized analog read signals.

2. The data storage device of claim 1, wherein the data storage device comprises a hard disk drive that includes the one or more disks, the one or more actuator mechanisms, the one or more heads, and the one or more processing devices.

3. The data storage device of claim 1, wherein:
the read operation comprises a first read operation; and
the one or more processing devices, individually or in combination, are further configured to perform the decoding the digitized analog read signals concurrently with performing a seek operation associated with a second read operation following the first read operation.

4. The data storage device of claim 1, wherein:
the one or more tracks comprise two or more tracks on the one or more corresponding disk surfaces; and
the read operation comprises reading the data from the two or more tracks simultaneously using two or more read elements.

5. The data storage device of claim 1, wherein the one or more buffers comprise a first buffer and a second buffer.

6. The data storage device of claim 5, wherein:
the first buffer is in a channel that is configured to perform the decoding; and
the second buffer is outside the channel.

7. The data storage device of claim 6, wherein:
the first buffer comprises a first type of memory; and
the second buffer comprises a second type of memory different than the first type of memory.

8. The data storage device of claim 5, wherein the one or more processing devices, individually or in combination, are further configured to:
initially store the digitized analog read signals in the second buffer; and
move respective ones of the digitized analog read signals from the second buffer to the first buffer prior to decoding the respective ones of the digitized analog read signals.

9. The data storage device of claim 5, wherein the one or more processing devices, individually or in combination, are further configured to:
store respective ones of the digitized analog read signals in the first buffer; and
store other respective ones of the digitized analog read signals in the second buffer based on the first buffer being full.

10. The data storage device of claim 9, wherein the one or more processing devices, individually or in combination, are further configured to:
move the other respective ones of the digitized analog read signals from the second buffer to the first buffer based on space becoming available in the first buffer.

11. The data storage device of claim 5, wherein the one or more processing devices, individually or in combination, are further configured to:
store a first respective one of the digitized analog read signals in the first buffer based on a first value of a qualitative metric associated with the first respective one of the digitized analog read signals; and
store a second respective one of the digitized analog read signals in the second buffer based on a second value of a qualitative metric associated with the second respective one of the digitized analog read signals.

12. The data storage device of claim 1, wherein the one or more processing devices, individually or in combination, are further configured to:
begin decoding of a respective one of the digitized analog read signals;
determine a value of one or more correction metrics based on the decoding of the respective one of the digitized analog read signals; and
stop the decoding of the respective one of the digitized analog read signals and store the respective one of the digitized analog read signals in the one or more buffers based on the value of the one or more correction metrics.

13. A method comprising:
performing a read operation in a data storage device, the read operation comprising reading data from one or more tracks on one or more corresponding disk surfaces in the data storage device;
storing digitized analog read signals associated with the read operation in one or more buffers; and
decoding the digitized analog read signals following the storing the digitized analog read signals,
wherein the first read operation, the storing, and the decoding are performed by one or more processing devices individually or in combination.

14. The method of claim 13, wherein the data storage device comprises a hard disk drive.

15. The method of claim 13, wherein:
the read operation comprises a first read operation; and
the one or more processing devices, individually or in combination, are further configured to perform the decoding the digitized analog read signals concurrently with performing a seek operation associated with a second read operation following the first read operation.

16. The method of claim 13, wherein:
the one or more buffers comprise a first buffer in a channel that performs the decoding and a second buffer outside the channel; and
the one or more processing devices, individually or in combination, are further configured to:
initially store the digitized analog read signals in the second buffer; and
move respective ones of the digitized analog read signals from the second buffer to the first buffer prior to decoding the respective ones of the digitized analog read signals.

17. The method of claim 13, wherein:
the one or more buffers comprise a first buffer in a channel that performs the decoding and a second buffer outside the channel; and
the one or more processing devices, individually or in combination, are further configured to:
store respective ones of the digitized analog read signals in the first buffer;
store other respective ones of the digitized analog read signals in the second buffer based on the first buffer being full; and
move the other respective ones of the digitized analog read signals from the second buffer to the first buffer based on space becoming available in the first buffer.

18. The method of claim 13, wherein:
the one or more buffers comprise a first buffer in a channel that performs the decoding and a second buffer outside the channel; and
the one or more processing devices, individually or in combination, are further configured to:
store a first respective one of the digitized analog read signals in the first buffer based on a first value of a qualitative metric associated with the first respective one of the digitized analog read signals; and
store a second respective one of the digitized analog read signals in the second buffer based on a second value of a qualitative metric associated with the second respective one of the digitized analog read signals.

19. The method of claim 13, wherein the one or more processing devices, individually or in combination, are further configured to:
begin decoding of a respective one of the digitized analog read signals;
determine a value of one or more correction metrics based on the decoding of the respective one of the digitized analog read signals; and
stop the decoding of the respective one of the digitized analog read signals and store the respective one of the digitized analog read signals in the one or more buffers based on the value of the one or more correction metrics.

20. One or more processing devices, individually or in combination, comprising:
means for performing a read operation in a data storage device, the read operation comprising reading data from one or more tracks on one or more corresponding disk surfaces in the data storage device;
means for storing digitized analog read signals associated with the read operation in one or more buffers; and
means for decoding the digitized analog read signals following the storing the digitized analog read signals.
